(19) United States
(12) Patent Application Publication
(10) Pub. No.: US 2016/0370940 A1
(43) Pub. Date: Dec. 22, 2016

(54) TOUCH DISPLAY DRIVING METHOD AND APPARATUS AND TOUCH DISPLAY SCREEN

(71) Applicant: BOE TECHNOLOGY GROUP CO., LTD., Beijing (CN)

(72) Inventor: Jiayang Zhao, Beijing (CN)

(21) Appl. No.: 14/770,376

(22) PCT Filed: Dec. 17, 2014
(86) PCT No.: PCT/CN2014/094075

§ 371 Date: Aug. 25, 2015

(30) Foreign Application Priority Data
Aug. 26, 2014 (CN) 201410426334.5

(51) Int. Cl. G06F 3/041

(52) U.S. Cl. CPC G06F 3/0418; G06F 3/0412

(57) ABSTRACT

The present disclosure provide a touch display driving method, a touch display driving apparatus and the touch display screen for reducing a touch noise. The touch display driving method comprises: in a display scanning period, implementing a display scanning operation on a display scanning region including multiple display scanning lines; in a touch scanning period, when there is an overlap between a touch scanning region corresponding to a current touch driving line and the display scanning region, skipping the touch scanning region which overlaps with the display scanning region, to implement a touch scanning operation on a touch scanning region corresponding to any touch driving line after the current touch driving line; and in a next touch scanning period, returning to implement a touch scanning operation on the touch scanning region which overlaps with the display scanning region. This effectively avoids an overlap between a touch scanning region and a display scanning region at a certain time, so as to thoroughly solve the problem that a touch noise occurs.

### TECHNICAL FIELD

The present disclosure relates to the field of touch and display technology, and in particular, to a touch display driving method and a touch display driving apparatus and a touch display screen.

### BACKGROUND

An embedded touch display screen is comprised of a touch screen and a display screen, and the touch screen is embedded in the display screen. An electrode of the touch screen comprises multiple touch driving lines Tx arranged horizontally and multiple touch sensing lines Rx arranged longitudinally. In the process of positioning and detecting a touch point, the touch driving lines Tx are scanned row by row. When each touch driving line Tx is scanned, signals on all touch sensing lines Rx are read. By scanning the touch sensing lines Rx column by column, intersection points between various touch driving lines and various touch sensing lines may be scanned, so as to detect a position of the touch point in the process of scanning.

Similarly to pixel units, touch units are arranged in an array. However, the touch units are different from the pixel units in size. Generally, multiple pixel units form a touch unit. Each row of touch units corresponds to a touch driving line Tx, and each column of touch units corresponds to a touch sensing line Rx. As shown in FIG. 1, illustrated is a diagram of a correspondence relationship between a touch driving line Tx and gate lines G. Each touch driving line Tx may correspond to M gate lines G, wherein M is a natural number larger than 1.

In terms of a display scanning operation and a touch scanning operation, the display scanning operation is to scan display scanning lines (i.e., gate lines G) row by row, and the touch scanning operation is to scan the touch driving lines Tx row by row. Further, a display scanning period and a touch scanning period are separated and occur alternatively. As shown in FIGS. 2 and 3a-3e, FIG. 2 is a timing diagram of alternatively implementing a display scanning operation and a touch scanning operation in the related art, and FIGS. 3a-3e are diagrams of alternatively implementing a display scanning operation and a touch scanning operation in the related art. In FIGS. 3a-3e, each horizontal line represents a gate line G, a display scanning line corresponds to a gate line G, and a touch driving line Tx corresponds to multiple gate lines G. As the display scanning operation is to scan the display scanning lines row by row and the touch scanning operation is to scan the touch driving lines Tx row by row, a region scanned by an touch scanning operation is much larger than a region scanned by a display scanning operation. Therefore, the touch scanning operation is implemented at a speed higher than that of the display scanning operation. This may result in an overlap between a display scanning region (display Y) and a touch scanning region (Tx X) at a certain time. As shown in FIG. 3d, the display scanning region (display Y) is included in the touch scanning region (Tx X),In addition, an additional scanning operation is required to be implemented on a noise environment in the touch scanning period. Thus, an output of a Gate driver on Array (GOA) is less stable than those of other regions. As a result, a touch noise may occur when an overlap exists.

### SUMMARY

In view of this, the present disclosure primarily aims to provide a touch display driving method and a touch display driving apparatus and a touch display screen for reducing a touch noise, so as to avoid the touch noise from occurring when there is an overlap between a touch scanning region and a display scanning region at a certain time.

For the above technical problem, the embodiments of the present disclosure provide a touch display driving method, comprising: in a display scanning period, implementing a display scanning operation on a display scanning region including multiple display scanning lines; in a touch scanning period, when there is an overlap between a touch scanning region corresponding to a current touch driving line and the display scanning region, skipping the touch scanning region which overlaps with the display scanning region, to implement a touch scanning operation on a touch scanning region corresponding to any touch driving line after the current touch driving line; and in a next touch scanning period, returning to implement a touch scanning operation on the touch scanning region which overlaps with the display scanning region, wherein the touch scanning region is larger than the display scanning region, the touch scanning operation is implemented at a scanning speed higher than that of the display scanning operation, and the touch scanning operation and the display scanning operation are implemented alternatively.

Preferably, in the touch scanning period, the method further comprises: judging whether there is an overlap between the touch scanning region and the display scanning region. Said judging whether there is an overlap between the touch scanning region and the display scanning region comprises: judging whether a last display scanning line in the display scanning region is in the touch scanning region corresponding to the current touch driving line, and if so, determining that there is an overlap between the touch scanning region and the display scanning region; otherwise, determining that there is no overlap between the touch scanning region and the display scanning region.

Preferably, any touch driving line behind the current touch driving line is a first touch driving line behind the current touch driving line.

Preferably, the touch driving line is a common electrode horizontally arranged in a touch screen.

Preferably, the touch display driving method is implemented by controlling a touch scanning signal and a display scanning signal, the touch scanning signal and the display scanning signal being transmitted by a touch driving circuit and a gate driving circuit respectively. The touch scanning signal and the display scanning signal are controlled by implementing software upgrading on the touch driving circuit and the gate driving circuit which transmit the touch scanning signal and the display scanning signal respectively.

The embodiments of the present disclosure further provide a touch display driving apparatus for implementing the touch display driving method, comprising: a display scanning signal generation apparatus configured to generate a display scanning signal, which is controlled to implement a display scanning operation on a display scanning region including multiple display scanning lines in a display scanning period; a touch scanning signal generation apparatus configured to generate a touch scanning signal, which is controlled to skip the touch scanning region which overlaps with the display scanning region to implement a touch scanning operation on a touch scanning region corresponding to any touch driving line after the current touch driving line when there is an overlap between a touch scanning region corresponding to a current touch driving line and the display scanning region in a touch scanning period, and return to implement a touch scanning operation on the touch scanning region which overlaps with the display scanning region in a next touch scanning period, wherein the touch scanning region is larger than the display scanning region, the touch scanning operation is implemented at a scanning speed higher than that of the display scanning operation, and the touch scanning operation and the display scanning operation are implemented alternatively.

Preferably, the touch scanning signal generation apparatus is a touch driving circuit, and the display scanning signal generation apparatus is a gate driving circuit.

The embodiments of the present disclosure further provide a touch display screen, comprising the touch display driving apparatus described above.

It can been seen from the above technical solutions that the present disclosure has the following beneficial effects:

The touch display driving method and the touch display driving apparatus and the touch display screen for reducing a touch noise according to the embodiments of the present disclosure control a touch scanning signal to skip the touch scanning region corresponding to the current touch driving line which overlaps with the display scanning region to implement a touch scanning operation on a touch scanning region corresponding to any touch driving line after the current touch driving line in a touch scanning period, and return to implement a touch scanning operation on the touch scanning region which overlaps with the display scanning region in a next touch scanning period. In this process, the display scanning operation is implemented normally. Thereby, this effectively avoids an overlap between a touch scanning region and a display scanning region at a certain time, so as to thoroughly solve the problem that a touch noise occurs due to the overlap between the touch scanning region and the display scanning region at a certain time, thereby largely improving the sensitivity of a touch operation.

### BRIEF DESCRIPTION OF THE DRAWINGS

FIG. 1 is a diagram of a correspondence relationship between a touch driving line Tx and gate lines.

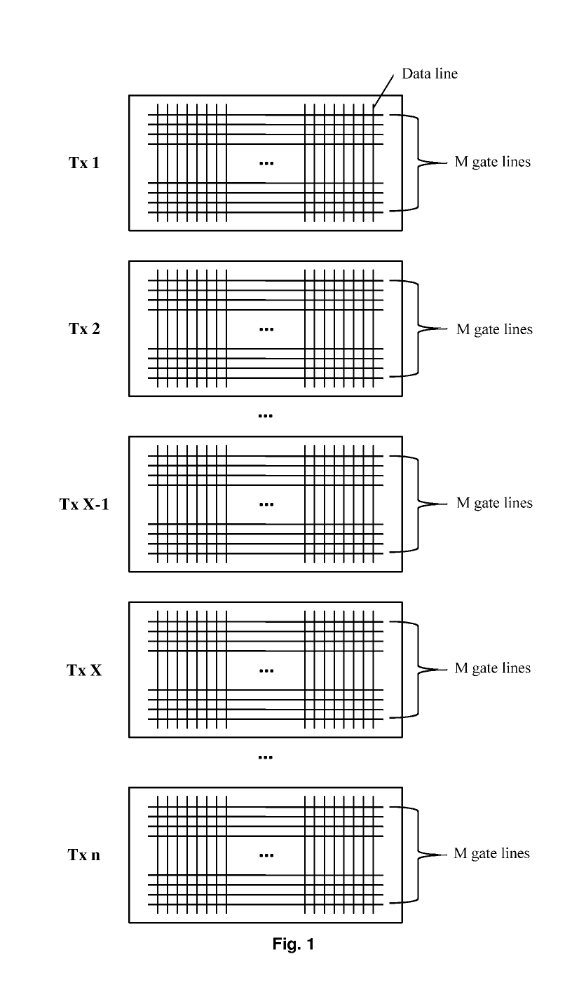

FIG. 2 is a timing diagram of alternatively implementing a display scanning operation and a touch scanning operation in the related art.

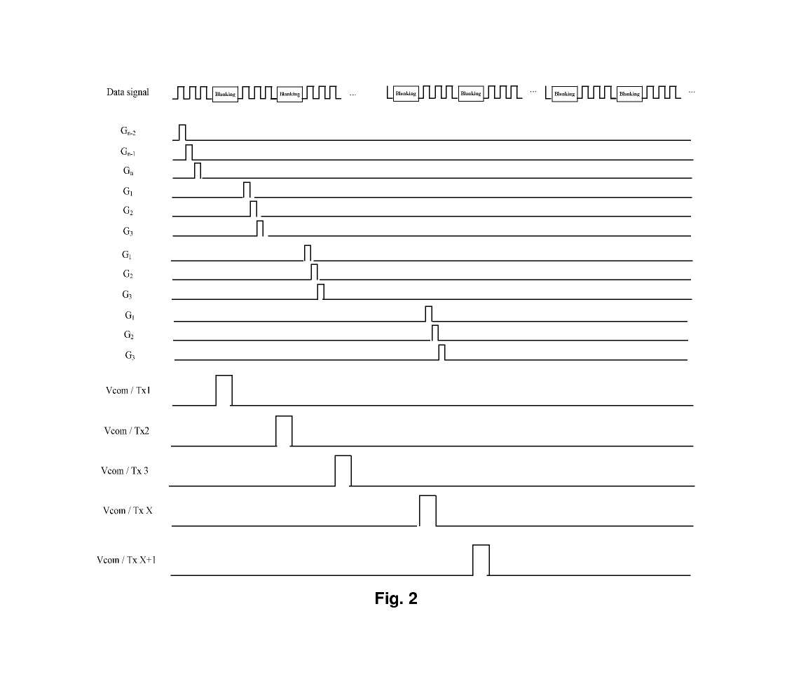

FIGS. 3a-3e are diagrams of alternatively implementing a display scanning operation and a touch scanning operation in the related art.

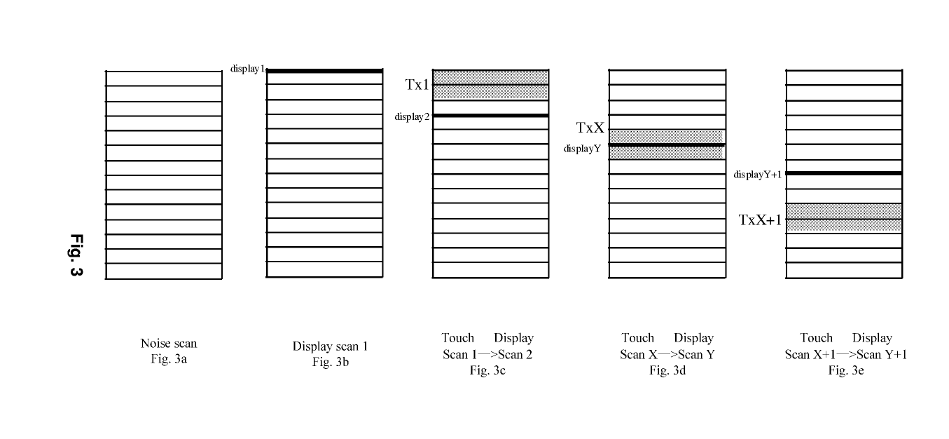

FIG. 4 is a timing diagram of alternatively implementing a display scanning operation and a touch scanning operation according to an embodiment of the present disclosure.

FIGS. 5a-5e are diagrams of alternatively implementing a display scanning operation and a touch scanning operation according to an embodiment of the present disclosure.

### DETAILED DESCRIPTION

In order to make the purpose, technical solutions, and advantages of the present disclosure more clear and obvious, the present disclosure will be further described in detail below in conjunction with specific embodiments and with reference to accompanying drawings.

For the problem that a touch noise may occur when there is an overlap between a touch scanning region and a display scanning region at a certain time, the embodiments of the present disclosure provide a touch display driving method, comprising:

in a display scanning period, implementing a display scanning operation on a display scanning region including multiple display scanning lines;

in a touch scanning period, when there is an overlap between a touch scanning region corresponding to a current touch driving line and the display scanning region, skipping the touch scanning region which overlaps with the display scanning region, to implement a touch scanning operation on a touch scanning region corresponding to any touch driving line after the current touch driving line; and

in a next touch scanning period, returning to implement a touch scanning operation on the touch scanning region which overlaps with the display scanning region,

wherein the touch scanning region is larger than the display scanning region, the touch scanning operation is implemented at a scanning speed higher than that of the display scanning operation, and the touch scanning operation and the display scanning operation are implemented alternatively.

In the present embodiment, in the touch scanning period, the method further comprises a step of: judging whether there is an overlap between the touch scanning region and the display scanning region. The specific judgment process is implemented by judging whether a last display scanning line in the display scanning region is in the touch scanning region corresponding to the current touch driving line, and if so, determining that there is an overlap between the touch scanning region and the display scanning region; otherwise, determining that there is no overlap between the touch scanning region and the display scanning region.

In the present embodiment, any touch driving line behind the current touch driving line is preferably a first touch driving line behind the current touch driving line.

In the present embodiment, the touch driving line is generally a common electrode horizontally arranged in a touch screen.

In the present embodiment, the touch display driving method is implemented by controlling a touch scanning signal and a display scanning signal, the touch scanning signal and the display scanning signal being transmitted by a touch driving circuit and a gate driving circuit respectively. The touch scanning signal and the display scanning signal are controlled by implementing software upgrading on the touch driving circuit and the gate driving circuit which transmit the touch scanning signal and the display scanning signal respectively without hardware changes, so that when there is an overlap between the touch scanning region corresponding to the touch driving line and the display scanning region, the touch scanning operation skips the touch scanning region which overlaps with the display scanning region to scan a touch scanning region corresponding to any touch driving line behind the touch driving line, and returns to scan the touch scanning region which overlaps with the display scanning region in a next touch scanning period. In this process, the display scanning operation is implemented normally.

Based on the above touch display driving method according to the embodiments of the present disclosure, the embodiments of the present disclosure further provide a touch display driving apparatus for implementing the touch display driving method, comprising: a display scanning signal generation apparatus configured to generate a display scanning signal, which is controlled to implement a display scanning operation on a display scanning region including multiple display scanning lines in a display scanning period; a touch scanning signal generation apparatus configured to generate a touch scanning signal, which is controlled to skip the touch scanning region which overlaps with the display scanning region to implement a touch scanning operation on a touch scanning region corresponding to any touch driving line after the current touch driving line when there is an overlap between a touch scanning region corresponding to a current touch driving line and the display scanning region in a touch scanning period, and return to implement a touch scanning operation on the touch scanning region which overlaps with the display scanning region in a next touch scanning period, wherein the touch scanning region is larger than the display scanning region, the touch scanning operation is implemented at a scanning speed higher than that of the display scanning operation, and the touch scanning operation and the display scanning operation are implemented alternatively.

In the present embodiment, the touch scanning signal generation apparatus is a touch driving circuit, and the display scanning signal generation apparatus is a gate driving circuit.

Based on the above touch display driving method and apparatus according to the embodiments of the present disclosure, the embodiments of the present disclosure further provide a touch display screen, comprising the touch display driving apparatus described above.

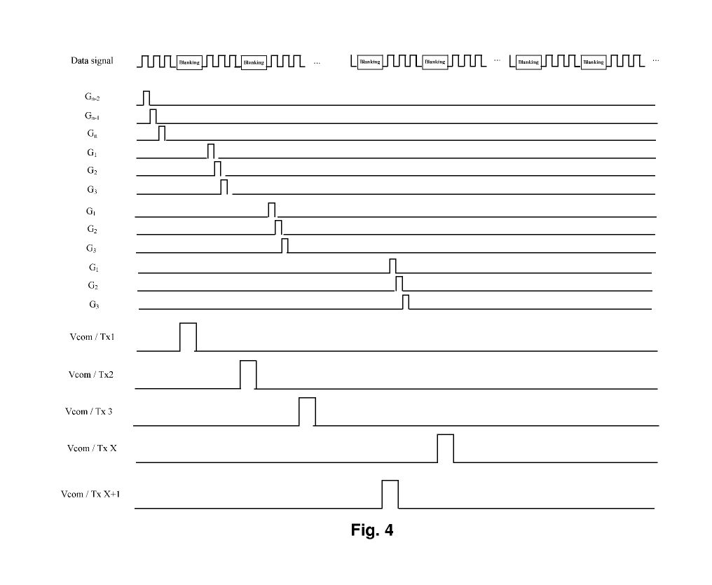

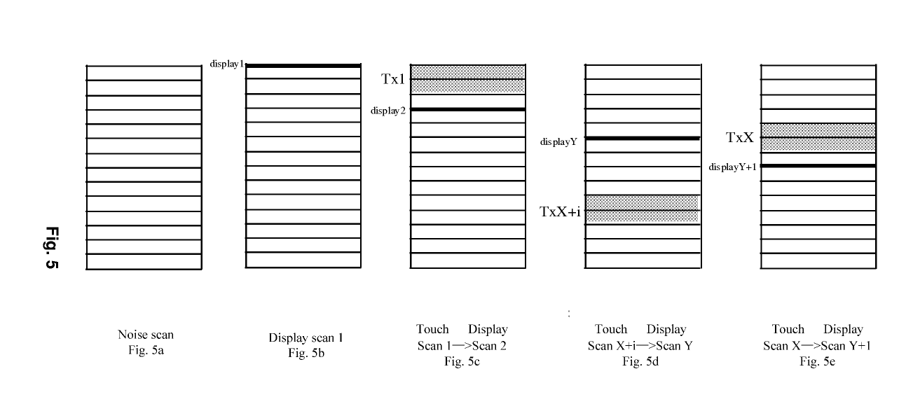

The touch display driving method according to the embodiment of the present disclosure will be further described in detail below with reference to FIGS. 5a-5e. As shown in FIGS. 5a-5e, it is assumed that a touch driving line Tx covers M gate lines, wherein M is a natural number larger than 1. According to the timing illustrated in FIG. 4, it is assumed that a display scanning operation is implemented on m gate lines between two times of touch scanning, wherein m is a natural number larger than 1. It is assumed that a number of noise scanning operations corresponding to each touch frame is j, a number of touch driving lines Tx is n. There is a touch scanning region corresponding to a touch driving line Tx X on which a touch scanning operation is being implemented, and a last gate line on which a display scanning operation is implemented on this region is Y, wherein Y and j are natural numbers. In this case, an overlap between a touch scanning region and a display scanning region may be described as follows.

It is assumed that a display scanning operation is implemented on the display panel at a frequency of 60 Hz, and a touch scanning operation is implemented on the display panel at a frequency of 120 Hz. Therefore, a display scan frame corresponds to two touch scan frames. As shown in FIG. 5c, as the touch scanning operation is implemented at speed higher than that of the display scanning operation, there is inevitably a case that a current touch scanning region includes a display scanning line on which a display scanning operation is implemented. That is,

When performing a scanning for a first touch frame, a last display scanning line Y1 on which a display scanning operation is implemented may be described as a function Y1=m(X+j) which is related to a touch driving line (Tx X).When the display scanning line Y1 is between two touch driving lines Tx (i.e., Tx X and Tx X+1), there is a condition that a touch scanning region corresponding to the current touch driving line Tx X includes a last display scanning line Y1 on which the display scanning operation is implemented. That is, there is an overlap between the touch scanning region corresponding to the current touch driving line Tx X and the display scanning region corresponding to the last display scanning line Y1 on which the display scanning operation is implemented.

When performing a scanning for a second touch frame is scanned, a last display scanning line Y2 on which a display scanning operation is implemented may be described as a function Y2 =m(X+n+2j) which is related to a touch driving line (Tx X). When the display scanning line Y2 is between two touch driving lines Tx (i.e., Tx X and Tx X+1), there is a condition that a touch scanning region corresponding to the current touch driving line Tx X includes a last display scanning line Y2 on which the display scanning operation is implemented. That is, there is an overlap between the touch scanning region corresponding to the current touch driving line Tx X and the display scanning region corresponding to the last display scanning line Y2 on which the display scanning operation is implemented.

During the first touch frame and the second touch frame, when there is an overlap between the touch scanning region corresponding to the current touch driving line and the display scanning region corresponding to the last display scanning line on which a display scanning operation is implemented, with the touch display driving method for reducing a touch noise according to the embodiment of the present disclosure, the display scanning operation is implemented normally, and the touch scanning operation skips the touch scanning region corresponding to the touch driving line Tx X which overlaps with the display scanning region, to scan a touch scanning region corresponding to a touch driving line Tx X+i behind the touch driving line Tx X, as shown in FIG. 5d, and then returns to scan the touch scanning region corresponding to the touch driving line Tx X in a next touch scanning period. As shown in FIG. 5e, this effectively avoids an overlap between a touch scanning region and a display scanning region at a certain time, so as to thoroughly solve the problem that a touch noise occurs due to the overlap between the touch scanning region and the display scanning region at a certain time, thereby largely improving the sensitivity of a touch operation.

When there is an overlap between a touch scanning region and a display scanning region, the touch scanning operation skips the touch scanning region corresponding to the touch driving line Tx X which overlaps with the display scanning region, to scan a touch scanning region corresponding to any touch driving line Tx X+i behind the touch driving line Tx X. Preferably, any touch driving line Tx X+i behind the touch driving line Tx X is a first touch driving line Tx X+1 behind the touch driving line Tx X, but the present disclosure is not limited thereto.

Further, after the touch scanning operation returns to scan the touch scanning region corresponding to the touch driving line Tx X in the next touch scanning period, the touch scanning operation and the display scanning operation are still implemented alternatively, and there is possibly still an overlap between a touch scanning region and a display scanning region in a subsequent scanning process. If a touch scanning region overlaps with a display scanning region again, for example, assuming that a touch scanning region corresponding to a touch driving line Tx X+k overlaps with a display scanning region corresponding to a last display scanning line Y+k on which a display scanning operation is implemented, wherein k is a natural number, the touch display driving scheme according to the embodiment of the present disclosure is still used. That is, the display scanning operation is implemented normally, and the touch scanning operation skips the touch scanning region corresponding to the touch driving line Tx X+k which overlaps with the display scanning region, to scan a touch scanning region corresponding to any touch driving line Tx X+k+i behind the touch driving line Tx X+k, and returns to scan the touch scanning region corresponding to the touch driving line Tx X+k in a next touch scanning period. Thereby, this effectively avoids an overlap between a touch scanning region and a display scanning region at a certain time, so as to thoroughly solve the problem that a touch noise occur due to the overlap between the touch scanning region and the display scanning region at a certain time, thereby largely improving the sensitivity of a touch operation.

The touch display driving method according to the embodiment of the present disclosure will be described in detail below by taking a display panel with a size of 5 inches and a resolution of HD720 as an example. In the present embodiment, it is assumed that there are totally 1280 gate lines G in the display panel, each touch driving line Tx covers M=67 gate lines G, then the last touch driving line Tx19 covers 74 gate lines, m=32, j=1, and n=19.

In a first touch frame, the above overlapping phenomenon occurs in a touch driving line Tx1 and a touch driving line Tx2. In this example, Y1=32*(X+1), and 67*(X−1)<32*(X+1)<=67*X, i.e., 35*X<99 and 35*X>=32. Thus, when X=1&2, an overlapping phenomenon occurs since Y1=64&96.That is, Y1=64&96 means that last display scanning lines on which a display scanning operation is implemented corresponding to the current touch scanning regions associated with the touch driving lines Tx1 and Tx2 are G64 and G96 respectively. Thus, the last display scanning line G64 on which a display scanning operation is implemented corresponding to the touch driving line Tx1 is included in a current touch scanning region corresponding to the touch driving line Tx1, i.e., there is an overlap between the touch scanning region corresponding to the current touch driving line Tx1 and the display scanning region corresponding to the last display scanning line G64 on which a display scanning operation is implemented; and the last display scanning line G96 on which a display scanning operation is implemented corresponding to the touch driving line Tx2 is included in a current touch scanning region corresponding to the touch driving line Tx2, i.e., there is an overlap between the touch scanning region corresponding to the current touch driving line Tx2 and the display scanning region corresponding to the last display scanning line G96 on which a display scanning operation is implemented.

In a case that there is an overlap between the touch scanning region corresponding to the current touch driving line Tx1 and the display scanning region corresponding to the last display scanning line G64 on which a display scanning operation is implemented, with the touch display driving method according to the embodiment of the present disclosure, the touch scanning operation skips the touch scanning region corresponding to the touch driving line Tx1 which overlaps with the display scanning region, to scan a touch scanning region corresponding to any touch driving line Tx 1+i behind the touch driving line Tx1, which preferably is a touch scanning region corresponding to a touch driving line Tx2, and returns to scan the touch scanning region corresponding to the touch driving line Tx1 in a next touch scanning period.

In a case that there is an overlap between the touch scanning region corresponding to the current touch driving line Tx2 and the display scanning region corresponding to the last display scanning line G96 on which a display scanning operation is implemented, with the touch display driving method according to the embodiment of the present disclosure, the touch scanning operation skips the touch scanning region corresponding to the touch driving line Tx2 which overlaps with the display scanning region, to scan a touch scanning region corresponding to any touch driving line Tx 2+i behind the touch driving line Tx2, which preferably is a touch scanning region corresponding to a touch driving line Tx3, and returns to scan the touch scanning region corresponding to the touch driving line Tx2 in a next touch scanning period.

In a second touch frame, the above overlapping phenomenon occurs in a touch driving line Tx19. In this example, Y2=32*(X+19+2) and 67*(X−1)<32*(X+21)<=67*X or 67*(X-1)<=32*(X+21)<67*X+7 for Tx19, i.e., 35*X<739 and 35*X>=672 or 35*X>=665. Thus, when X=19, an overlapping phenomenon occurs since Y2=1280. Y2=1280 means that a last display scanning line on which a display scanning operation is implemented corresponding to the current touch scanning region associated with the touch driving line Tx19 is G1280. Thus, the last display scanning line G1280 on which a display scanning operation is implemented is included in a current touch scanning region corresponding to the touch driving line Tx19, i.e., there is an overlap between the touch scanning region corresponding to the current touch driving line Tx19 and the display scanning region corresponding to the last display scanning line G1280 on which a display scanning operation is implemented.

In a case that there is an overlap between the touch scanning region corresponding to the current touch driving line Tx19 and the display scanning region corresponding to the last display scanning line G1280 on which a display scanning operation is implemented, with the touch display driving method according to the embodiment of the present disclosure, the touch scanning operation skips the touch scanning region corresponding to the touch driving line Tx19 which overlaps with the display scanning region, to scan a touch scanning region corresponding to any touch driving line Tx19+i behind the touch driving line Tx19, which is preferably a touch scanning region corresponding to a touch driving line Tx20, and returns to scan the touch scanning region corresponding to the touch driving line Tx19 in a next touch scanning period.

The above specific embodiments further describe the purposes, technical solutions and beneficial effects of the present disclosure in detail. It should be understood that the above description is merely specific embodiments of the present disclosure, instead of limiting the present disclosure. Any modification, equivalent substitution, improvement etc., made within the spirit and principle of the present disclosure, should be included in the protection scope of the present disclosure.

1. A touch display driving method, comprising:
in a display scanning period, implementing a display scanning operation on a display scanning region including multiple display scanning lines;
in a touch scanning period, when there is an overlap between a touch scanning region corresponding to a current touch driving line and the display scanning region, skipping the touch scanning region which overlaps with the display scanning region, to implement a touch scanning operation on a touch scanning region corresponding to any touch driving line after the current touch driving line; and
in a next touch scanning period, returning to implement a touch scanning operation on the touch scanning region which overlaps with the display scanning region,
wherein the touch scanning region is larger than the display scanning region, the touch scanning operation is implemented at a scanning speed higher than that of the display scanning operation, and the touch scanning operation and the display scanning operation are implemented alternatively.

2. The method according to claim 1, wherein in the touch scanning period, the method further comprises:
judging whether there is an overlap between the touch scanning region and the display scanning region.

3. The method according to claim 2, wherein said judging whether there is an overlap between the touch scanning region and the display scanning region comprises:
judging whether a last display scanning line in the display scanning region is in the touch scanning region corresponding to the current touch driving line, and if so, determining that there is an overlap between the touch scanning region and the display scanning region; otherwise, determining that there is no overlap between the touch scanning region and the display scanning region.

4. The method according to claim 1, wherein any touch driving line behind the current touch driving line is a first touch driving line behind the current touch driving line.

5. The method according to claim 1, wherein the touch driving line is a common electrode horizontally arranged in a touch screen.

6. The method according to claim 1, wherein the touch display driving method is implemented by controlling a touch scanning signal and a display scanning signal, the touch scanning signal and the display scanning signal being transmitted by a touch driving circuit and a gate driving circuit respectively.

7. The method according to claim 6, wherein the touch scanning signal and the display scanning signal are controlled by implementing software upgrading on the touch driving circuit and the gate driving circuit which transmit the touch scanning signal and the display scanning signal respectively.

8. A touch display driving apparatus, comprising:
a display scanning signal generation apparatus configured to generate a display scanning signal, with controls to implement a display scanning operation on a display scanning region including multiple display scanning lines in a display scanning period; and
a touch scanning signal generation apparatus configured to generate a touch scanning signal, with controls to skip the touch scanning region which overlaps with the display scanning region to implement a touch scanning operation on a touch scanning region corresponding to any touch driving line after the current touch driving line when there is an overlap between a touch scanning region corresponding to a current touch driving line and the display scanning region in a touch scanning period, and return to implement a touch scanning operation on the touch scanning region which overlaps with the display scanning region in a next touch scanning period,
wherein the touch scanning region is larger than the display scanning region, the touch scanning operation is implemented at a scanning speed higher than that of the display scanning operation, and the touch scanning operation and the display scanning operation are implemented alternatively.

9. The apparatus according to claim 8, wherein the touch scanning signal generation apparatus is a touch driving circuit.

10. The apparatus according to claim 8, wherein the display scanning signal generation apparatus is a gate driving circuit.

11. A touch display screen, comprising the touch display driving apparatus according to claim 8.

12. The touch display screen according to claim 11, wherein the touch scanning signal generation apparatus is a touch driving circuit.

13. The touch display screen according to claim 11, wherein the display scanning signal generation apparatus is a gate driving circuit.
